(19) United States
(12) Patent Application Publication
(10) Pub. No.: US 2006/0100374 A1
(43) Pub. Date: May 11, 2006

(54) Gasket material

(76) Inventors: Yoshiaki Hamada, Saitama City (JP); Koji Akiyoshi, Saitama City (JP); Yasunori Murakami, Wako City (JP); Masamune Tabata, Wako City (JP)

Correspondence Address: YOUNG & THOMPSON, 745 SOUTH 23RD STREET, 2ND FLOOR, ARLINGTON, VA, 22202, US

(21) Appl. No.: 10/520,177

(22) PCT Filed: Apr. 30, 2003
(86) PCT No.: PCT/JP03/05547

§ 371 Date: Sep. 29, 2005

(30) Foreign Application Priority Data
Jul. 5, 2002 (JP) 2002-196714
Jul. 5, 2002 (JP) 2002-196827
Jul. 5, 2002 (JP) 2002-196972
Jul. 5, 2002 (JP) 2002-196980

(51) Int. Cl. C08L 21/00; F16J 15/00; F16J 9/00

(52) U.S. Cl. 525/132; 277/345

(57) ABSTRACT

The gasket material that is manufactured from a joint seat which includes three layers, that is, a front surface layer (1a), a back surface layer (1b) and the middle layer (1c), and these layers have different composition of reinforced fiber and filler respectively, and this joint seat is made from an ingredient made by mixing and kneading rubber, reinforced fiber and filler, then pressurized laminating and vulcanizing the ingredient, this joint seat is characterized in that the reinforced fiber is as a sort of fibril which is composed from one or both of organic fiber and non-asbestos type inorganic fiber, and at least a part of the filler is spicular inorganic fiber and its composition is 10 wt %-45 wt %. According to this joint seat (1), a crack breakage of the gasket that the ingredient material is the joint seat (1) due to fretting is prevented.

### FIELD OF THE INVENTION

The present invention is related to a gasket material which is used for an engine and a transmission for automotive and the like, especially, this gasket material is manufactured from a joint seat which is made from an ingredient made by mixing and kneading rubber, reinforced fiber and filler, and pressurized laminating and vulcanizing the ingredient. And this invention is also related to a gasket that is made by using such gasket material.

### BACKGROUND OF THE INVENTION

Up to now, so-called asbestos joint seat was used as the material of the gasket for the circumference of the engine carried on the vehicles and so on, such joint seat is manufactured by binding asbestos by nitrile rubber and phenol resin, and formed to laminating material.

However, recently, this asbestos joint seat is imposed regal controls because of its influence of environment, so that the applicants of this application are studying a joint seat which uses another fiber materials instead of asbestos, and presents the result of such study as a paper “Development of non-asbestos gasket material” which is contained in a proceedings of a lecture meeting published by Society of Automotive Engineers of Japan, Inc. at May, 1992.

By the way, as shown in FIG. 14, when a gasket is used to a structural body such as a gasket insert portion between a transmission housing H joined with a engine and a cover C connected to the housing H by means of bolt B which the body has a large temperature change by means of a repeating drive and stop of engine and the like, a repeated relative displacement (fretting) is generated between the attaching surfaces of the housing H and the gasket G caused from the repeated temperature change as shown by an arrow in FIG. 15. And there is advanced the low rigidity of the structural body such as housing H and cover C because of the recent weight saving of the automotive, so such fretting is also generated by the external force that is acted on the cover C and the like.

At the same time, the present joint seat that includes the seat with asbestos as an reinforced fiber has a low anti-tensile force, especially, in the generally used joint seat with 0.5 mm thickness, there is still not developed the joint seat that has the high anti-tensile force over 40 MPa. Therefore, if a gasket that is manufactured from such present joint seat as the material is used at the periphery of engine and the like, the gasket G is misaligned from its original position by the above-mentioned fretting shown by the arrow F in FIG. 5, and in the worst case, there is a problem that the crack and the breakage of the gasket happens and the leakage of the sealing media is generated.

So the applicant tried the solutions to prevent the crack and the breakage of the gasket by lowering the fretting by means of increase the fastening surface pressure via adding the number of the fastening bolt of the structural body or increasing the rigidity of the cover and the like, or provide the mating structure at the attaching surface at the gasket insert portion of the structural body by means of the knock pins.

However, these solutions such as lowering the fretting by means of increase the fastening-surface pressure via adding the number of the fastening bolt of the structural body or increasing the rigidity of the cover and the like, or provide the mating structure at the attaching surface at the gasket insert portion of the structural body by the knock pins incurs the cost increase of the structural body due to the complicating of the fastening structure, and the weight increase of the structural body due to the increasing the number of the parts and large sizing of the parts.

Moreover, in the present joint seat, the difference of the sticking force between the front surface and the back surface is small. Thus, if a gasket that is manufactured from such present joint seat as the material is used at the periphery of engine and the like, as shown in FIG. 15, there is a problem that a slip S happens at the both surface of the gasket G relative to the structural body such as the housing H and the cover C due to the above-mentioned fretting F, the gasket G is misaligned from its original position by means of the friction force which is generated when the slip S happens, and the portion P which protrudes from the gasket insert portion is generated, thus, the seal efficiency becomes decrease as shown in FIG. 16 and FIG. 17.

Therefore, the applicant tried the following solutions to prevent the decrease of the sealing effect of the gasket;

1) Lowering the fretting quantity by means of increase the fastening surface pressure via adding the number of the fastening bolt of the structural body or increasing the rigidity of the cover and the like;

2) Improve the bearing force of the gasket against the fretting by increasing the mechanical strength of the gasket;

3) Lowering the fretting quantity by providing the mating structure at the attaching surface at the gasket insert portion of the structural body by the knock pins;

4) Decreasing the force to misalign the position of the gasket by decrease the friction via applying a solid lubricant such as graphite or molybdenum disulfide to the surface of the gasket.

However, these solutions such as lowering the fretting by means of increase the fastening surface pressure via adding the number of the fastening bolt of the structural body or increasing the rigidity of the cover and the like has the problems that incurs the cost increase of the structural body due to the complicating of the fastening structure, and the weight increase of the structural body due to the increasing the number of the parts and large sizing of the parts, and the solution that increasing the mechanical strength of the gasket has a problem that the joint seat and then the gasket becomes hard, thus the compression quantity became decrease, so that the sealing effect becomes worse adversely.

Furthermore, the solution that providing the mating structure at the attaching surface at the gasket insert portion of the structural body by the knock pins has a problem that incurs the cost increase of the structural body due to the complicating of the fastening structure, and the weight increase of the structural body due to the increasing the number of the parts and large sizing of the parts, and the solution that applying a solid lubricant such as a graphite or molybdenum disulfide to the surface of the gasket has a problem that increases the fretting quantity and accelerating the occurrence of deformation of the gasket with low strength due to the slip between the gasket and the cover or the like becomes large by the solid lubricant.

Additionally, as described above, the present joint seat that includes the seat with the reinforce fiber of asbestos has low tensile strength (anti-tensile force), so that if a gasket that is manufactured from such present joint seat as the material is used at the periphery of engine and the like, the gasket is misaligned from its original position by the fretting and the leakage of the sealing media occurs due to decrease of the surface pressure.

Therefore, the following the variety of the methods for high strengthening the joint seat is studied, but all of these methods are not sufficient. That is, there is the methods that intend to improve the strength of the gasket by increasing the composition quantity of the reinforce fiber or by increasing the fiber length of the reinforce fiber to increase the monophorogy effect, but these methods has the problems that occurs the runup of the ingredient cost of the gasket and the decrease of the sealing efficiency due to the aggravation of the smoothness of the surface of the gasket.

And there are the other methods that intend to increase the density of the gasket and therefore improve the strength of the gasket by enhancing the roll pressure in the forming the laminated joint seat, and to facilitate the curing of the joint seat and therefore improve the strength of the gasket by raising the temperature of the hot roll in the forming of the laminated joint seat and thus increasing the curing temperature of the composed rubber material. However, as shown in FIG. 18, these methods have the problems that when the strength of the joint seat increases to some degree, the hardness of the gasket is too high, so the durability of the gasket which is against the repeated compression stress is decrease, and in the worst case, the buckling fatigue of the gasket occurs, that is, the permanent compression strain of the gasket with side flowage due to the compression breakage, and consequently, it brings the decrease of the sealing efficiency of the gasket as shown in FIG. 18.

Moreover, there are the other methods that intend to increase the strength of the gasket by reducing the composition rate of rubber material at blending of the ingredient of the joint seat thus the joint seat make more hard, or by increase the rate of the acrylic nitrile that is the series of NBR more than 40% at blending of the rubber material in the joint seat. However, these methods also have the problems that the flexibility of the joint seat become decrease, and when the stress that is directed to the thrust is acted on the gasket by fretting under the work of the surface pressure, a large settling, that is, a permanent compression strain that make the thickness decrease occurs and thus the sealing efficiency of the gasket become decrease.

Additionally, for example, as shown in FIG. 20, when a gasket is used to a structural body such as a gasket insert portion between a transmission housing H joined with a engine and a cover C connected to the housing H by means of bolt B which the body has a large temperature change by means of a repeating drive and stop of engine and the like, a relative displacement is generated between the attaching surfaces of the housing H and the gasket G caused from the repeated temperature change as shown by an arrow D. On the other hand, since the gasket that is made from the joint seat as the raw material has a high friction resistance because the rubber composition exists in the surface, this gasket is hard to slip.

Thus, heretofore, when the gasket that is made from the joint seat as the raw material is used at the peripheral of the engine like the transmission, there is a problem that a fretting wear-out portion W occurs on the both surface of the gasket because of the sliding by the above-mentioned relative displacement.

So, to solve such problem of the wear-out of the gasket, the applicant tried the following solutions to decrease the wear-out quantity according to make the surface of the gasket having a low friction; At plate making of the joint seat 1 with triple layer structure that comprises a front surface layer 1a, a back surface layer 1b, and a middle layer that lies between both of the surface layers, a solid lubricant such as fluorocarbon resin, molybdenum disulfide, mica is added into the ingredient of the front surface layer 1a and is dispersed in the ingredient as shown in FIG. 21; Decrease the composition rate of rubber material in joint seat 1 itself; On the front surface layer 1a of the joint seat 1 with triple layer structure that comprises a front surface layer 1a, a back surface layer 1b, and a middle layer that lies between both of the surface layers, a solid lubricant such as graphite powder or molybdenum disulfide powder is applied by the splay method or the like as shown in FIG. 22.

However, these solutions still have the following problems, that is, the solution that a solid lubricant such as fluorocarbon resin, molybdenum disulfide, mica is added into the ingredient of the front surface layer 1a and is dispersed in the ingredient is difficult to achieve the decline of the friction coefficient due to the upper limit of the composition of the solid lubricant sufficiently, thus the decrease of the wear-out quantity is not enough; The solution that decreasing the composition rate of rubber material in joint seat 1 itself can not decline the composition of rubber material until it can acquire sufficient friction coefficient due to the constrain of plate making condition; And the solution that a solid lubricant such as graphite powder or molybdenum disulfide powder is applied on the surface layer to make the low friction coating 2 of the solid lubricant has a problem that a electrical corrosion portion EC is generated by the gasket at the gasket insert portion which depend on the material of the housing H and cover C or the kind of the sealing media.

### DISCLOSURE OF THE INVENTION

The object of this invention is to provide the gasket material to be solved the above-mentioned problems advantageously. The gasket material in the first point of view of this invention that is manufactured from a joint seat which is made from an ingredient made by mixing and kneading rubber, reinforced fiber and filler, then pressurized laminating and vulcanizing the ingredient, is characterized in that said reinforced fiber is as a sort of fibril which is composed from one or both of organic fiber and non-asbestos type inorganic fiber, and at least a part of said filler is spicular inorganic fiber and its composition is 10%-45 wt %.

According to the gasket material of this invention, the reinforced fiber is as a sort of fibril (miniaturized fiber) which is composed from one or both of organic fiber and non-asbestos type inorganic fiber (inorganic fiber instead of asbestos), and at least a part of said filler is spicular inorganic fiber and its composition is 10%-45 wt %, thereby the anti-tensile force of the joint seat is increased by mutual involve of the miniaturized fiber which is composed from said organic fiber and inorganic fiber and additional involve of said miniaturized fiber and said spicular inorganic fiber, so that, if the fretting occurs on the structural body such as housing and cover, the occurrence of the crack breakage of the gasket due to the misalignment of the gasket from its original position is prevented.

In the gasket material of this invention, it is preferable that a phenolic antioxidant adds to the ingredient at 2 wt %-26 wt %. Since the phenolic antioxidant with 2 wt %-26 wt % gives the ingredient of the joint seat adequate sticking efficient, as forming the joint seat by feeding the ingredient on a hot roll of a calender roll which comprises a pair of the roll of a hot roll and a cold roll and compressing and laminating the ingredient, the laminating of the ingredient can be achieved stably without the capture of the ingredient by the cold roll.

Moreover, in the gasket material of this invention, the fundamental component of the ingredient with said phenolic antioxidant is preferably composed from that aramid fiber as the reinforce fiber is over 15 wt %, NBR as the rubber material is 10%-30 wt %, phenolic antioxidant is 2 wt %-26 wt %, magnesium silica hydrate as the spicular inorganic fiber, and the remainder is inorganic filler as the filler material. According to these composition, as described hereinafter, the joint seat will have the over 45 MPa anti-tensile force with 0.5 mm thickness which generally used as gasket.

Furthermore, in the gasket material of this invention, said spicular inorganic fiber preferably has 40 μm-200 μm of major axis of the particle. The particle with such major axis value provides a favorable formability and can achieve sufficient anti-tensile force of the joint seat.

The gasket material in the second point of view of this invention that is manufactured from a joint seat which is made from an ingredient made by mixing and kneading rubber, reinforced fiber and filler, then pressurized laminating and vulcanizing the ingredient, is characterized in that one of the both outermost layers is formed as non-adhering layer with weak adherence and another one is formed as adhering layer with strong adherence.

According to the gasket material of this invention, one of the both outermost layers that consists the gasket material is formed as non-adhering layer with weak adherence and another one is formed as adhering layer with strong adherence, so that although the fretting occurs at the structural body such as housing and cover, the adhering layer of the gasket that is formed from the gasket material adheres the gasket to the structural body and maintain it at the original position, furthermore, the non-adhering layer gives the gasket a slip S against the structural body by a small friction force, therefore, decrease of the seal efficiency which due to the displacement of the gasket from its original position is prevented.

Moreover, in the gasket material of this invention, the adherence of said adhering layer is preferably over 5 times of the adherence of said non-adhering layer, and the adherence of said adhering layer is preferably over 2.5 MPa. If the adherence of said adhering layer is over 5 times of the adherence of said non-adhering layer and the adherence of said adhering layer is over 2.5 MPa, as describes later, sufficient seal durability of the gaskets against the fretting will be obtained.

Furthermore, in the gasket material of this invention, the component of said adhering layer is preferably composed from that coumarone-indene resin is 2 wt %-15 wt %, calcium carbonate is 5 wt %-60 wt %, NBR is 10%-25 wt %, and the layer includes these components that total composition of these components is under or equal to 100 wt %. According to these component, as describes later, the adherence of said adhering layer is over 5 times of the adherence of said non-adhering layer and the adherence of said adhering layer is over 2.5 MPa, so sufficient seal durability of the gaskets against the fretting will be obtained.

Moreover, the gasket material in the third point of view of this invention that is manufactured from a joint seat which is made from an ingredient made by mixing and kneading rubber, reinforced fiber and filler, and pressurized laminating and vulcanizing the ingredient, is characterized in that the fundamental component of the ingredient is composed from that aramid fiber as the reinforce fiber is over 20 wt %, the rubber material is 23 wt %-30 wt %, barium sulfate as the filler is 7 wt %-30 wt %, and the remainder is inorganic filler as the filler material.

According to the gasket material of this invention, aramid fiber that its composition is over 20 wt % and barium sulfate that its composition is 7 wt %-30 wt % enhances the strength of the joint seat with maintaining its high flexibility, so that, if the fretting occurs on the structural body such as housing and cover, the occurrence of the crack breakage of the gasket due to the misalignment of the gasket from its original position is prevented.

Furthermore, this gasket material is intended to enhance the strength by neither increase the compounding ratio of the reinforce fiber nor increase the fiber length of the reinforce fiber, so that it can maintain the ingredient cost of the gasket in low cost and can make the surface of the gasket smooth and make the sealing efficiency increase sufficiently. And this joint seat also intend to enhance the strength by neither increase the roll pressure at the layer-forming of the joint seat nor increase the temperature of the hot roll, so that it can keep the low hardness of the joint seat and acquire the endurance of the gasket against the repeated compression stress, therefore, the decline of the sealing effect of the gasket due to its buckling fatigue can be prevented.

Moreover, this gasket material is intended to enhance the strength by neither decrease of the compounding ratio of the rubber material at composition of the joint seat nor increase the rate of the acrylic nitrile component in NBR, so that it can maintain the flexibility of the joint seat in high level and therefore, the decline of the sealing effect of the gasket due to large wear-out of the gasket can be prevented with resist the stress of thrust direction by the fretting under the influence of the surface pressure.

Additionally, in the gasket material of this invention, the specific surface area of said aramid fiber is preferably over 6 m²/g. If the specific surface area of aramid fiber which indicates the degree of fibril is 6 m²/g, the tensile strength and the buckling fatigue surface pressure of the joint seat and thus that of the gasket can be increased sufficiently.

Moreover, in the gasket material of this invention, the mean particle diameter of said barium sulfate is preferably under 3 μm. If the barium sulfate powder which its mean particle diameter is 3 μm is used, the buckling fatigue surface pressure of the joint seat and thus that of the gasket increases especially.

Furthermore, the gasket material in the fourth point of view of this invention that is manufactured from a joint seat which is made from an ingredient made by mixing and kneading rubber, reinforced fiber and filler, and pressurized laminating and vulcanizing the ingredient, is characterized in that the low friction coating is formed on the single side or the both side of said joint seat by applying the low friction treatment liquid that includes polytetrafluoroethylene (PTFE).

According to the gasket material of this invention, the low friction coating that is formed on the single side or the both side of said joint seat by applying the low friction treatment liquid that includes polytetrafluoroethylene can acquire sufficient low friction coefficient of the surface of the gasket, so that, if the relative displacement between the attaching surfaces of the housing H or cover C or the like and gasket G that is made from the gasket material of this invention, the fretting wear-out of the surface of the gasket G that is made from the gasket material of this invention can be prevented, and its sealing efficiency can increase drastically rather than the gasket that is made from the present joint seat.

Additionally, in the gasket material of this invention, said treatment liquid is preferably made by mixing the emulsion of polytetrafluoroethylene with 30 wt %-85 wt % and the resol of phenol resin with 15 wt %-70 wt % with keeping the total weight percentage 100 wt %. According to this composition of the liquid, low friction coefficient of the gasket can maintain instead of the increase of the number of the cycle of sliding, and since the surface of the joint seat is covered by PTFE that is bound by phenol resin, the absorption of moisture of the joint seat and thus the corrosion of housing H and cover C and the like is prevented.

Furthermore, in the gasket material of this invention, the thickness of said coating is preferably over 3 μm. If the thickness of said coating is over 3 μm, the low friction coefficient of the gasket can be maintained in a long term although the coating wears gradually.

### BRIEF EXPLANATION OF THE DRAWING

FIG. 1 shows a cross sectional view of a joint seat as the embodiment 1 of the gasket material of this invention in above the first point of view and the embodiment 2 of the gasket material of this invention in above the second point of view.

FIG. 2 shows a diagram of the anti-tensile force of the joint seat as a gasket material of above embodiment 1 in contradistinction to that of the present non-asbestos type gasket and the present gasket including asbestos.

FIG. 3 shows a cross sectional view of the action of the gasket that is made from the gasket material of the embodiment 2 against fretting.

FIG. 4 shows a cross sectional view of a joint seat as the embodiment 3 of the gasket material of this invention in above the third point of view

FIG. 5 shows a diagram of the anti-tensile force of the joint seat as a gasket material of above embodiment 3 in comparison with that of the present commercially available gasket.

FIG. 6 shows a diagram of the buckling fatigue surface pressure of the joint seat as a gasket material of above embodiment 3 in comparison with that of the present commercially available gasket.

FIG. 7 shows a diagram of the limit seal pressure of the joint seat as a gasket material of above embodiment 3 in comparison with that of the present commercially available gasket.

FIG. 8 shows a diagram of the relation of the particle diameter of the barium sulfate that is binding in the ingredient of the joint seat of the embodiment 3 and the buckling fatigue surface pressure and the limit seal pressure of the joint seat.

FIG. 9 shows a diagram of the relation of the specific surface area of aramid fiber that is binding in the ingredient of the joint seat of the embodiment 3 and the tensile strength and the buckling fatigue surface pressure of the joint seat.

FIG. 10 shows a cross sectional view of a joint seat as the embodiment 4 of the gasket material of this invention in above the fourth point of view

FIG. 11 shows a relational diagram of the result of sliding test of the samples of the above embodiment 4 and the comparative samples.

FIG. 12 shows a diagram of the result of measurement of the sticking strength to cover of the samples of the above embodiment 4 and the comparative samples.

FIG. 13 a diagram of the result of measurement of the weight increase rate due to absorbing moisture of the samples of the above embodiment 4 and the comparative samples.

FIG. 14 shows a cross sectional view of the gasket that is inserted between a housing and a cover of a transmission.

FIG. 15 shows a cross sectional view of the action of the gasket that is made from the present commercially available gasket material against fretting.

FIG. 16 shows a cross sectional view of the protrusion of the present gasket due to its displacement.

FIG. 17 shows a plan view of the protrusion of the present gasket due to its displacement.

FIG. 18 shows a diagram of the relation between the tensile strength and the buckling fatigue surface pressure of the present joint seat.

FIG. 19 shows a diagram of the relation between the tensile strength and the limit seal pressure of the present joint seat.

FIG. 20 shows a cross sectional view of the gasket that is inserted between a housing and a cover of a transmission.

FIG. 21 shows a cross sectional view of an example of the surface of the gasket with low friction coefficient.

FIG. 21 shows a cross sectional view of an example of the surface of the gasket with low friction coefficient.

FIG. 22 shows a cross sectional view of another example of the surface of the gasket with low friction coefficient.

### THE BEST MODE FOR PRACTICING THE INVENTION

There will be described hereinafter an embodiment according the present invention, with reference to the accompanying drawings.

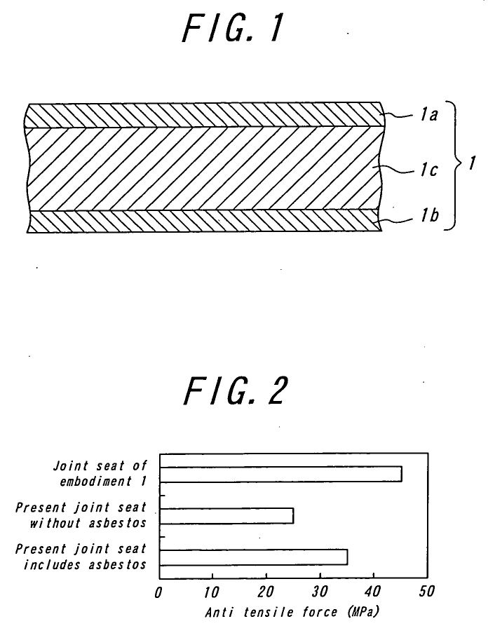

FIG. 1 shows a cross sectional view of the embodiment 1 of the gasket material of this invention in above-mentioned the first point of view, the numeral 1 indicates a joint seat as the gasket material of this embodiment, this joint seat 1 has three-layer construction, that is, a front surface layer 1a and a back surface layer 1b and a middle layer 1c that exists between the front surface and back surface layer.

This joint seat 1 of the embodiment 1 is formed by following process; at first, a ingredient material is made by mixing rubber such as NBR, miniaturized reinforced fiber that is fibrillated fiber such as aramid fiber as an organic fiber and glass fiber as an inorganic fiber instead of asbestos, spicular inorganic filler and the other filler such as barium sulfate, then this ingredient material feeds on a hot roll of a calender roll which comprises a pair of rolls, namely, hot roll and cold roll, forming a laminated ingredient on the hot roll by mixing and pressing with the use of these rolls, furthermore forming a joint seat by vulcanizing and curing the ingredient with the use of the heat of the hot roll, hereinafter the joint seat 1 forms by detaching the seat from the hot roll. In this process, as shown in FIG. 1, the above-mentioned the front surface layer 1a, the back surface layer 1b and the middle layer 1c of the three layers of the joint seat 1 are formed by mainly varying the composing quantity of the reinforced fiber (As for the more detail of this process, please refer the aforementioned paper “Development of non-asbestos gasket material”).

In this joint seat 1 of the embodiment 1, the fundamental component of the ingredient with said phenolic antioxidant is preferably composed from that fibrillated aramid fiber as the reinforce fiber is over 15 wt %, NBR (Nitrile-Butadiene-Rubber) as the rubber material is 10%-30 wt %, phenolic antioxidant is 2 wt %-26 wt %, magnesium silica hydrate as the spicular inorganic fiber, and the remainder is inorganic filler.

In this joint seat, as the magnesium silica hydrate, a spicular crystallized material which a major axis of the particle is 40 μm-200 μm is used. The spicular particle with the range of this major axis provides a favorable formability and can achieve sufficient anti-tensile force of the joint seat.

According to this joint seat 1 of the embodiment 1, the reinforced fiber is fibrillated type and the filler includes a spicular inorganic filler material, so the anti-tensile force of the joint seat is increased by mutual involve of the miniaturized fiber which is composed from said organic fiber and inorganic fiber and additional involve of said miniaturized fiber and said spicular inorganic fiber, so that, if the fretting occurs on the structural body such as housing and cover, the occurrence of the crack breakage of the gasket due to the misalignment of the gasket from the original position is prevented.

FIG. 2 shows the anti-tensile force of the joint seat 1 of this embodiment 1 in contradistinction to that of the present non-asbestos type gasket and the present gasket including asbestos. As seen from this diagram, the joint seat 1 of this embodiment 1 has an extremely higher anti-tensile force than that of the present non-asbestos type gasket and the present gasket including asbestos.

### EXAMPLE 1

The following Table 1 shows the result of the test of the anti-tensile force of the joint seat samples that Sample 1-1 to 1-3 are joint seat 1 with the same thickness 0.5 mm and different blending composition respectively, and Comparative sample 1-1 and 1-2 are joint seat which is similar to the joint seat 1 with the same thickness 0.5 mm and each of the composition of the spicular fiber are 0 wt % and 50 wt % respectively. These samples are made and tested its anti-tensile force by the tensile test under the condition that is defined in JIS K 6251. As seen from these results, both of the Comparative samples 1-1 and 1-2 has anti-tensile force under 40 MPa, on the other hand, all of the Samples 1-1 to 1-3 has anti-tensile force over 45 MPa and it is understand that these samples is the gasket material with sufficiently high anti-tensile force.

TABLE 1

| | Composition (wt %) | | | | | |
|---|---|---|---|---|---|---|
| | | | Spicular | | | Anti-tensile |
| Examples of | aramid | | inorganic | Phenolic | inorganic | force |
| composition | fiber | rubber | filler | antioxidant | filler | (MPa) |
| Sample 1-1 | 25 | 26 | 38 | 8 | remainder | 45 |
| Sample 1-2 | 25 | 25 | 30 | 12 | remainder | 47 |
| Sample 1-3 | 23 | 23 | 17 | 16 | remainder | 49 |
| Comparative | 25 | 25 | 0 | 10 | remainder | 37 |
| sample 1-1 | | | | | | |
| Comparative | 25 | 25 | 50 | 0 | remainder | 30 |
| sample 1-2 | | | | | | |

In the above samples, the aramid fiber is fibrillated aromatic polyamide fiber (pulp type), the rubber is NBR, the spicular inorganic filler is spicular crystallized material of magnesium silica hydrate, the phenolic antioxidant is bis- or tri-polyphenolic resin or resolic phenol resin, and the inorganic filler is barium sulfate, clay or the like.

Moreover, this invention is not limited by the above-mentioned samples, for example, the joint seat may be multi-layer construction that has two layers, that is, either of a front surface layer or a back surface layer so-called dish component that corresponds to the front surface layer 1a or the back surface layer, and a main layer so-called a middle component that corresponds to the middle layer 1c. Alternatively, the joint seat may be monolayer structure that has only a middle component that corresponds to the middle layer 1c.

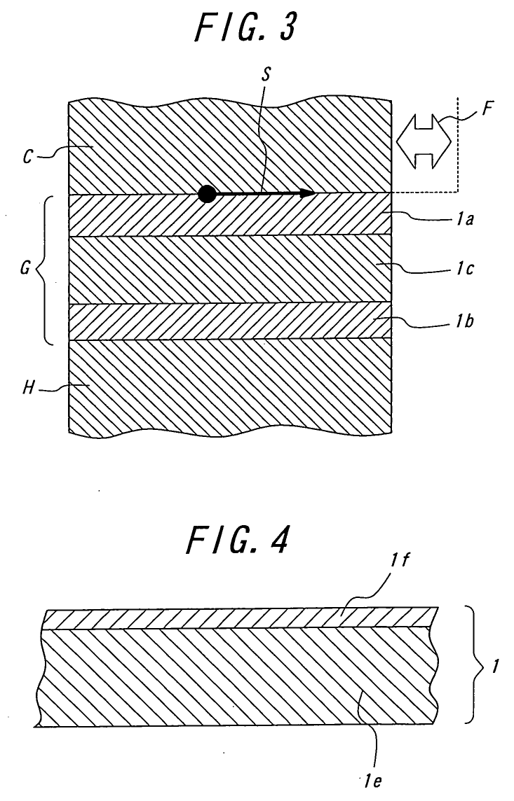

Then, FIG. 3 shows a cross sectional view of the action of the gasket that is made from the gasket material of the embodiment 2 against fretting. As shown in FIG. 1, the joint seat 1 as the gasket material of this embodiment 2 is multi-layer structure that comprises three layers, that is, a front surface layer 1a, a back surface layer 1b, and a middle surface layer 1c.

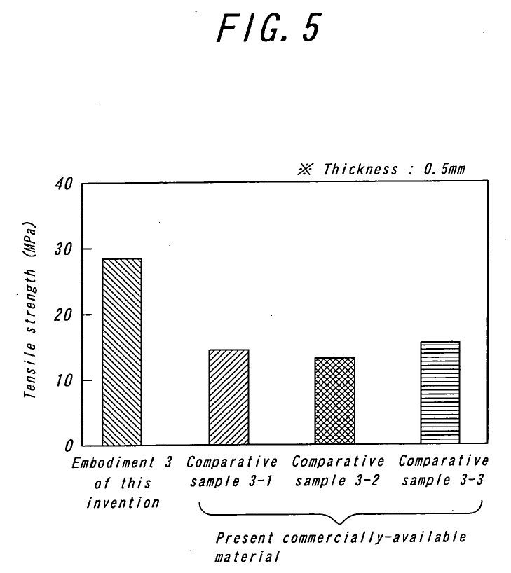

This joint seat 1 of the embodiment 2 is formed by following process; at first, a ingredient material is made by mixing rubber such as NBR, reinforced fiber that is the fiber instead of asbestos such as aramid fiber or glass fiber, and filler such as barium sulfate, then this ingredient material feeds on a hot roll of a calender roll which comprises a pair of rolls, namely, hot roll and cold roll, forming a laminated ingredient on the hot roll by mixing and pressing with the use of these rolls, furthermore forming a joint seat by vulcanizing and curing the ingredient with the use of the heat of the hot roll, hereinafter the joint seat 1 forms by detaching the seat from the hot roll. In this process, the above-mentioned the front surface layer 1a, the back surface layer 1b and the middle layer 1c of the three layers of the joint seat 1 are formed by mainly varying the composing quantity of the reinforced fiber (As for the more detail of this process, please refer the aforementioned paper “Development of non-asbestos gasket material”). In this connection, in page 179 of this paper, FIG. 5 shows an examples of the composition of aramid fiber, glass fiber and NBR of the middle layer, especially, in the percentage of composition that is indicated by point 5, aramid fiber is about 24 wt %, glass fiber is about 33 wt % and NBR is about 43 wt %.

In this joint seat 1 of the embodiment 2, the front surface layer which is one of the both outermost surface layer, that is, the front surface layer 1a or the back surface layer 1b is configured as a non-adhering layer with low adherence, and the back surface layer 1b, another outermost surface layer is configured as a adhering layer with high adherence. The adherence of the back surface layer 1b is over five times of that of the front surface layer 1a, and the adherence of the back surface layer 1b is over 2.5 MPa.

To obtain the above-mentioned adherence, the component of the back surface layer of the joint seat 1 of this embodiment 2 is composed from that coumarone-indene resin is 2 wt %-15 wt %, calcium carbonate is 5 wt %-60 wt %, NBR is 10 wt %-25 wt %, and the layer includes these components that total composition of these components is under or equal to 100 wt %.

According to this joint seat 1 of the embodiment 2, one of the both outermost layers is formed as non-adhering layer with weak adherence and another one is formed as adhering layer with strong adherence, so that, as shown in FIG. 2, although the fretting F occurs at the structural body such as housing H and cover C, the back surface layer 1b of the gasket G that is formed from the joint seat 1 adheres the gasket G to the structural body such as housing H and maintain it at the original position, furthermore, the front surface layer 1a gives the gasket G a slip S against the structural body such as cover C by a small friction force, therefore, decrease of the seal efficiency which due to the displacement of the gasket G from its original position is prevented.

Furthermore, in this joint seat 1 of the embodiment 2, since the component of the back surface layer 1b is composed from that coumarone-indene resin is 2 wt %-15 wt %, calcium carbonate is 5 wt %-60 wt %, NBR is 10%-25 wt %, and the layer includes these components that total composition of these components is under or equal to 100 wt %, and the adherence of the back surface layer 1b is over 5 times of the adherence of the front surface layer 1a and the adherence of said layer 1b is over 2.5 MPa, so sufficient seal durability of the gasket G against the fretting can be obtained.

### EXAMPLE 2

In the above-mentioned embodiment 2, Samples 2-1 to 2-6 of the joint seat 1 that have 0.5 mm thickness are made by differing the composition of the front surface layer 1a and the back surface layer 1b respectively, the gasket samples are formed from each samples of the joint seat 1, insert these samples between the housing H and the cover C of the actual transmission, and the fretting durability test of these gasket samples at their insert portion under the condition that each samples are fastened between the housing H and the cover C by bolts at the axial force of a bolt is 1 ton, the temperature of the transmission is 80° C., and twist load at the direction of the reciprocating rotation acted between the input shaft and the output shaft of the transmission of 100N·m at 3000 cycles. The result that there is no deformation of the gasket by the displacement and all of the gasket has excellent durability.

TABLE 2
Sample 2-1

| Difference of | 6.46 (front surface/back surface) | | | |
|---|---|---|---|---|
| adhering force | | | | |
| Gasket surface | front surface | | back surface | |
| Adhering | 0.85 | | 5.49 | |
| force(MPa) | | | | |
| Composition of | NBR | 25 | NBR | 25 |
| gasket (wt %) | aramid fiber | 15 | calcium carbonate | 30 |
| | clay powder | 50 | powder | |
| | | | coumarone-indene | 10 |
| | | | resin | |

| | |
|---|---|
| aramid fiber | remainder |

TABLE 3
Sample 2-2

| Difference of | 7.97 (front surface/back surface) | | | |
|---|---|---|---|---|
| adhering force | | | | |
| Gasket surface | front surface | | back surface | |
| Adhering | 0.35 | | 2.79 | |
| force(MPa) | | | | |
| Composition of | NBR | 12 | NBR | 25 |
| gasket (wt %) | aramid fiber | 13 | calcium carbonate | 10 |
| | clay powder | 50 | powder | |
| | graphite powder | 25 | silica powder | 4.5 |
| | | | coumarone-indene | 6 |
| | | | resin | |

| | |
|---|---|
| aramid fiber | remainder |

TABLE 4
Sample 2-3

| Difference of | 8.18 (front surface/back surface) | | | |
|---|---|---|---|---|
| adhering force | | | | |
| Gasket surface | front surface | | back surface | |
| Adhering | 0.71 | | 5.81 | |
| force(MPa) | | | | |
| Composition of | NBR | 15 | NBR | 25 |
| gasket (wt %) | aramid fiber | 15 | calcium carbonate | 50 |
| | clay powder | 40 | powder | |
| | silica powder | 30 | coumarone-indene | 10 |
| | | | resin | |
| | | | aramid fiber | remainder |

TABLE 5
Sample 2-4

| Difference of | 12.10 (front surface/back surface) | | | |
|---|---|---|---|---|
| adhering force | | | | |
| Gasket surface | front surface | | back surface | |
| Adhering | 0.41 | | 4.96 | |
| force(MPa) | | | | |
| Composition of | NBR | 15 | NBR | 15 |
| gasket (wt %) | aramid fiber | 10 | calcium carbonate | 15 |
| | clay powder | 25 | powder | |
| | mica powder | 50 | talc | 35 |
| | | | coumarone-indene | 15 |
| | | | resin | |

| | |
|---|---|
| aramid fiber | remainder |

TABLE 6
Sample 2-5

| Difference of | 7.14 (front surface/back surface) | | | |
|---|---|---|---|---|
| adhering force | | | | |
| Gasket surface | front surface | | back surface | |
| Adhering | 0.81 | | 5.78 | |
| force(MPa) | | | | |
| Composition of | NBR | 12 | NBR | 20 |
| gasket (wt %) | NR | 3 | calcium carbonate | 45 |
| | aramid fiber | 20 | powder | |
| | clay powder | 55 | coumarone-indene | 9 |
| | | | resin | |
| | | | aramid fiber | remainder |

TABLE 7
Sample 2-6

| Difference of | 17.86 (front surface/back surface) | | | |
|---|---|---|---|---|
| adhering force | | | | |
| Gasket surface | front surface | | back surface | |
| Adhering | 0.14 | | 2.50 | |
| force(MPa) | | | | |
| Composition of | NBR | 15 | NBR | 15 |
| gasket (wt %) | aramid fiber | 20 | calcium carbonate | 35 |
| | mica powder | 12 | powder | |
| | clay powder | 18 | coumarone-indene | 5 |
| | molybdenum | 25 | resin | |
| | disulfide powder | | barium sulfate | 15 |
| | teflon dispersion | 10 | aramid fiber | remainder |

Moreover, this invention is not limited by the above-mentioned samples, for example, the joint seat may be multi-layer construction, that has two layers, that is, either of a front surface layer or a back surface layer as the adhering layer and main layer that is composed from the so-called middle component that corresponds to the middle layer 1c as a non-adhering layer.

FIG. 4 shows a cross sectional view of the embodiment 3 of the gasket material of this invention in above-mentioned the third point of view, the numeral 1 indicates a joint seat as the gasket material of this embodiment, this joint seat 1 has multi-layer construction which comprises two layers, that is, a main layer 1e that is so-called middle component and a surface layer 1f that is dish component.

This joint seat 1 of the embodiment 3 is formed by following process; at first, a ingredient material is made by mixing rubber such as NBR, reinforced fiber that is composed from a fibrillated (miniaturized) fiber such as aramid fiber, barium sulfate as filler and the other inorganic filler such as clay, then this ingredient material feeds on a hot roll of a calender roll which comprises a pair of rolls, namely, hot roll and cold roll, forming a laminated ingredient on the hot roll by mixing and pressing with the use of these rolls, furthermore forming a joint seat by vulcanizing and curing the ingredient with the use of the heat of the hot roll, hereinafter the joint seat 1 forms by detaching the seat from the hot roll. In this process, as shown in FIG. 4, the above-mentioned the main layer 1e, and the surface layer 1f of the two layers of the joint seat 1 are formed by mainly varying the composing quantity of the reinforced fiber (As for the more detail of this process, please refer the aforementioned paper “Development of non-asbestos gasket material”).

In this joint seat 1 of the embodiment 3, the fundamental component of the ingredient is composed from that aramid fiber as the reinforced fiber is over 20 wt %, NBR (Nitrile-Butadiene-Rubber) as the rubber material is 23 wt %-30 wt %, barium sulfate as the filler is 7 wt %-30 wt %, and the other inorganic filler is remainder.

In this embodiment, for example, aromatic polyamide fiber (pulp type) is used as said aramid fiber that the specific surface area of this fiber that indicates the degree of fibril is over 6 m²/g. If this specific surface area of this aramid fiber is over 6 m²/g, as describes hereinafter, the tensile strength and the buckling fatigue surface pressure of the joint seat and thus that of the gasket can be increased sufficiently.

And in this embodiment, barium sulfate that has the mean particle diameter under 3 μm is used. If the barium sulfate powder which its mean particle diameter is 3 μm is used, the buckling fatigue surface pressure of the joint seat and thus that of the gasket increases especially.

According to this joint seat 1 of the embodiment 3, aramid fiber with over 20 wt % and barium sulfate with 7 wt %-30 wt % are enhance the strength of the joint seat with maintaining its high flexibility, so that if the fretting occurs on the structural body such as housing and cover, the clack breakage of the gasket which is caused by the displacement of the gasket from its original position can be prevented.

Moreover, this gasket material is intended to enhance the strength by neither increase the compounding ratio of the reinforce fiber nor increase the fiber length of the reinforce fiber, so that it can maintain the ingredient cost of the gasket in low cost and can make the surface of the gasket smooth and make the sealing efficiency increase sufficiently. And this joint seat also intend to enhance the strength by neither increase the roll pressure at the layer-forming of the joint seat nor increase the temperature of the hot roll, so that it can keep the low hardness of the joint seat and acquire the endurance of the gasket against the repeated compression stress, therefore, the decline of the sealing effect of the gasket due to its buckling fatigue can be prevented.

Moreover, this gasket material is intended to enhance the strength by neither decrease of the compounding ratio of the rubber material at composition of the joint seat nor increase the rate of the acrylic nitrile component in NBR, so that it can maintain the flexibility of the joint seat in high level and therefore, the decline of the sealing effect of the gasket due to large wear-out of the gasket can be prevented with resist the stress of thrust direction by the fretting under the influence of the surface pressure.

Therefore, according to this joint seat 1 of the embodiment 3, when the rigidity of the structural body such as transmission is low and a high bolt fastening force acted on the gasket insert potion between this structural body such as the housing and the cover, if some force acted on the structural body such as the cover and its deformation occurs, the gasket can achieve an excellent sealing durability. That is, when the rigidity of the structural body is low, the surface pressure that is generated at the gasket insert portion at the beneath of the fastening bolt or the vicinity of such bolt is high, but the pressure is low in the span between the bolts. Thus, it is required that the gasket should have a high endurance against buckling and a sealing efficiency due to its excellent flexibility, the joint seat 1 of this embodiment 3 can achieve these effects.

Furthermore, in the design of the sealing portion of the structural body by the joint seal 1 of the embodiment 3, the characteristics of this joint seat 1 can enhance the degree of freedom of the pitch and the size of the fastening bolt and the thickness of the cover, thus the weight saving of the structural body can be achieved.

FIG. 5 shows the result of tensile test about the joint seat 1 of the embodiment 3 and the three kind of comparative samples 3-1 to 3-3, the present commercially available joint seats under the condition which is defined in JIS K 6251, and this diagram shows the tensile strength of these joint seats comparing the sample of this embodiment and the comparative samples. As seen from this diagram, the tensile strength of the joint seat 1 of this embodiment 3 (more specifically, approximate mean value of the samples 3-1 to 3-7 describes hereinafter) is considerably higher than that of the present commercially available joint seats.

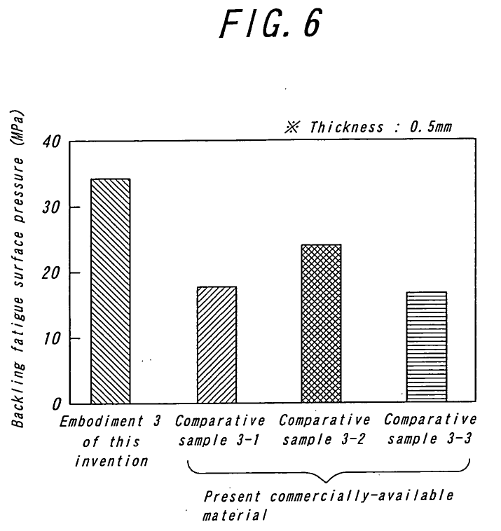

And FIG. 6 shows the result of buckling fatigue test about the joint seat 1 of the embodiment 3 and the three kind of comparative samples 3-1 to 3-3, the present commercially available joint seats under the condition that each ring-shaped samples are set between a pair of plates and one of the plate was reciprocating slid at the distance of movement 300 μm and frequency 1 Hz by an actuator with loading a predetermined surface pressure by the hydropress whether the fluff of the fiber generates or not at reciprocating cycle 3000 cycle, and the buckling fatigue-surface pressure is determined as the surface pressure when the fluff of the sample is generated, and this diagram shows the buckling fatigue surface pressure of these joint seats comparing the sample of this embodiment and the comparative samples. As seen from this diagram, the buckling fatigue surface pressure of the joint seat 1 of this embodiment 3 (more specifically, approximate mean value of the samples 3-1 to 3-7 describes hereinafter) is considerably higher than that of the present commercially available joint seats.

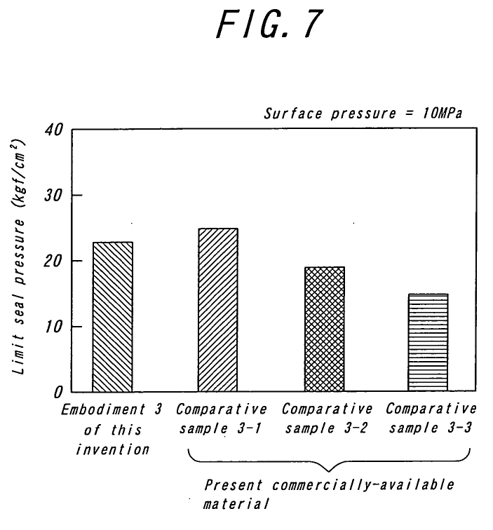

Moreover, FIG. 7 shows a result of the limit seal pressure test about the joint seat 1 of the embodiment 3 and the three kind of comparative samples 3-1 to 3-3, the present commercially available joint seats under the condition that the nitrogen gas was supplied to inside the sample which the fluff generated via the plates and the soap solution was applied to the periphery of the sample to check the leakage of the nitrogen gas, and the limit seal pressure is measured as the gas pressure when the leakage is generated. As seen from this diagram, the limit seal pressure of the joint seat 1 of this embodiment 3 (more specifically, approximate mean value of the samples 3-1 to 3-7 describes hereinafter) is approximately equivalent to the highest value of the limit seal pressure of the present commercially available joint seats.

### EXAMPLE 3

The following Table 8 shows the result of tensile test, buckling fatigue test and limit seal pressure test about the joint seat samples, the Samples 3-1 to 3-7 are the joint seat 1 of said embodiment 3, the thickness of all of these samples is 0.5 mm, but each of these samples have different composition, the Comparative samples 3-1 to 3-6 are the joint seats that the thickness of all of these comparative samples is 0.5 mm, and the composition of these comparative samples are according to the joint seat 1 but the composition of aramid fiber or barium sulfate is outside the scope of the embodiment 3. These test are carried out under the above-mentioned condition. These result shows that the Comparative samples 3-1 to 3-6 has low value of any of tensile strength, buckling fatigue surface pressure and limit seal pressure, but all of the Samples 3-1 to 3-7 has high tensile strength over 5 MPa, and holds high buckling fatigue surface pressure over 80 MPa, and has high limit seal pressure over 2.0 kgf/cm². It is understood that these samples of the embodiment 3 is gasket material with excellent characteristics.

TABLE 8

| | | | | | Performance of joint seat | | |
|---|---|---|---|---|---|---|---|
| | Composition (wt %) | | | | tensile | buckling fatigue | limit seal |
| Examples of | aramid | barium | | inorganic | strength | surface pressure | pressure |
| composition | fiber | sulfate | rubber | filler | (MPa) | (MPa) | (kgf/cm²) |
| Sample 3-1 | 20 | 7 | 23 | remainder | 26.7 | 69 | 2.2 |
| Sample 3-2 | 20 | 20 | 23 | remainder | 25.3 | 89 | 2.6 |
| Sample 3-3 | 20 | 30 | 23 | remainder | 25.1 | 90 | 2.2 |
| Sample 3-4 | 30 | 20 | 23 | remainder | 28.8 | 86 | 2.2 |
| Sample 3-5 | 40 | 20 | 23 | remainder | 30.7 | 87 | 2.0 |
| Sample 3-6 | 20 | 7 | 27 | remainder | 26.1 | 86 | 2.4 |
| Sample 3-7 | 20 | 7 | 30 | remainder | 25.8 | 84 | 2.6 |
| Comparative | 20 | 5 | 23 | remainder | 26.2 | 69 | 2.2 |
| sample 3-1 | | | | | | | |
| Comparative | 20 | 40 | 23 | remainder | 18.6 | 78 | 2.0 |
| sample 3-2 | | | | | | | |
| Comparative | 15 | 20 | 23 | remainder | 17.9 | 73 | 2.8 |
| sample 3-3 | | | | | | | |
| Comparative | 20 | 7 | 18 | remainder | 27.1 | 67 | 1.5 |
| sample 3-4 | | | | | | | |
| Comparative | 20 | 7 | 20 | remainder | 26.8 | 69 | 1.5 |
| sample 3-5 | | | | | | | |
| Comparative | 20 | 7 | 33 | remainder | 18.7 | 61 | 2.6 |
| sample 3-6 | | | | | | | |

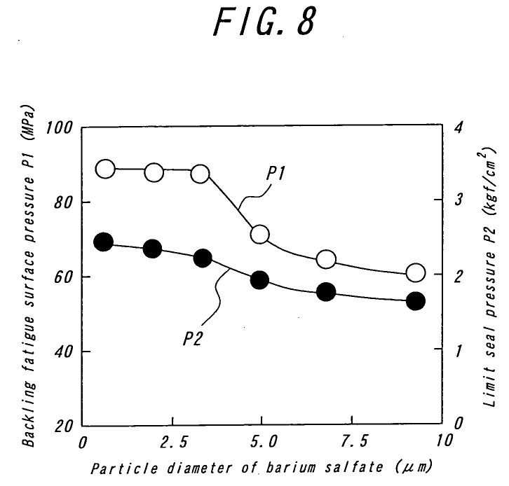

FIG. 8 shows the result of the study of contribution of the particle shape of barium sulfate according to the characteristic of buckling fatigue and of limit seal pressure by the buckling fatigue test and the limit seal pressure test under the similar condition of above-mentioned test, the fundamental composition of the joint seat 1 of the embodiment 1 is that aramid fiber is 20 wt %, NBR is 23 wt %, barium sulfate is 20 wt % and the remainder is inorganic filler, and the particle diameter of barium sulfate differs in each samples. As seen from this diagram, when the particle diameter of barium sulfate becomes over 4 μm, the buckling fatigue surface pressure P1 apparently tends to decrease, and the limit seal pressure also tend to decrease as the particle diameter of barium sulfate become large. Thus the barium sulfate is preferably microscopic powder with its diameter is under 3 μm. Moreover, the above-mentioned the result that is shown in FIG. 18 and FIG. 19 is obtained from the buckling fatigue test and the limit seal pressure test under the same condition.

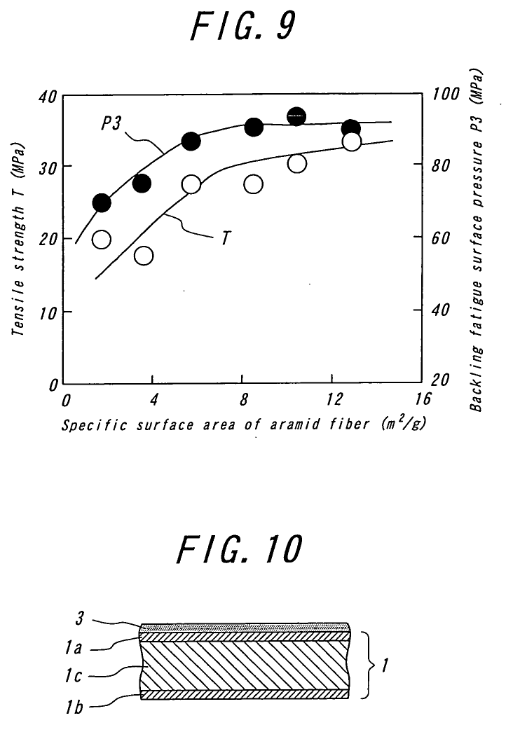

FIG. 9 shows the result of the study of contribution of the degree of fibrillation of aramid fiber according to the tensile strength and the characteristic of buckling fatigue by the tensile test and the buckling fatigue test under the similar condition of above-mentioned test, the fundamental composition of the joint seat 1 of the embodiment 1 is that aramid fiber is 20 wt %, NBR is 23 wt %, barium sulfate is 7 wt % and the remainder is inorganic filler, and the specific surface area of aramid fiber differs in each samples. As seen from this diagram, when the specific surface area of the aramid fiber that indicates the degree of fibrillation becomes below 6 m²/g, the decrease of the tensile stress occurs, and the characteristic of buckling fatigue tends to decrease in sync with the decrease of the tensile stress. Therefore, the specific surface area of aramid fiber is preferably over 6 m²/g.

Furthermore, this invention is not limited by the above-mentioned samples, for example, the joint seat may be multi-layer construction that has three layers, that is, either of a front surface layer and a back surface layer so-called dish component that corresponds to the surface layer 1f and a main middle layer so-called a middle component that corresponds to the main layer 1e. Alternatively, the joint seat may be monolayer structure that has only a middle component that corresponds to the middle layer 1e.

Finally, FIG. 10 shows a cross sectional view of the embodiment 4 of the gasket material of this invention in said the fourth point of view, the numeral 1 indicates a joint seat 1 that has three-layer construction which comprises a front surface layer 1a, a back surface layer 1b and a middle layer 1c that exists between the front surface and back surface layer. And the numeral 3 indicates a low friction coating.

In manufacturing this gasket material of the embodiment 4, at first, a ingredient material is made by mixing rubber such as NBR, reinforced fiber that is the fiber instead of asbestos such as aramid fiber or glass fiber, and filler such as barium sulfate, then this ingredient material feeds on a hot roll of a calender roll which comprises a pair of rolls, namely, hot roll and cold roll, forming a laminated ingredient on the hot roll by mixing and pressing with the use of these rolls, furthermore forming a joint seat by vulcanizing and curing the ingredient with the use of the heat of the hot roll, hereinafter the joint seat 1 forms by detaching the seat from the hot roll. In this process, the above-mentioned the front surface layer 1a, the back surface layer 1b and the middle layer 1c of the three layers of the joint seat 1 are formed by mainly varying the composing quantity of the reinforced fiber (As for the more detail of this process, please refer the aforementioned paper “Development of non-asbestos gasket material”). In this connection, in page 179 of this paper, FIG. 5 shows an examples of the composition of aramid fiber, glass fiber and NBR of the middle layer, especially, in the percentage of composition that is indicated by point 5, aramid fiber is about 24 wt %, glass fiber is about 33 wt % and NBR is about 43 wt %.

Then, a low friction treatment liquid which includes polytetrafluoro-ethylene (PTFE) applies the surface of the front surface layer 1a of the joint seat 1 by a roll coater, for example, to make the quantity of the application is 300 mg/m²-1500 mg/m², and this low friction treatment liquid is heated and dried, thereby, a low friction coating 3 forms on the front surface layer 1a which its thickness is over 3 μm as shown in FIG. 10.

In this embodiment, said low friction treatment liquid which includes PTFE is preferably made from mixing PTFE of an emulsion type (for example, product name D-1 of DAIKIN Industries Ltd., and its solid content is 60 wt %) at 30 wt %-85 wt % and phenol resin of a resol type (for example, product name CT-E300 of Nihon Parkerizing Co. Ltd., and its solid content is 10%) to make the total percentage of weight become 100 wt %.

According to this gasket material of the embodiment 4, a low friction coating 3 that is formed by applying a low friction treatment liquid which includes PTFE can acquire low friction coefficient μ, so that, if the relative displacement between the attaching surfaces of the housing H or cover C or the like and gasket G that is made from the gasket material of this embodiment 4, the fretting wear-out of the surface of the gasket G can be prevented, and its sealing efficiency can increase drastically rather than the gasket G that is made from the present joint seat.

Moreover, if the low friction treatment liquid is made by mixing the polytetrafluoroethylene of emulsion type with 30 wt %-85 wt % and the phenol resin of resol type with 15 wt %-70 wt % and keeping the total weight percentage 100 wt %, as describes hereinafter, low friction coefficient of the gasket can maintain instead of the increase of the number of the cycle of sliding, and since the surface of the joint seat is covered by PTFE that is bound by phenol resin, the absorption of moisture of the joint seat and thus the corrosion of housing H and cover C and the like is prevented.

Furthermore, according to this gasket material of the embodiment 4, since the thickness of the low friction coating is over 3 μm, the low friction coefficient of the gasket can be maintained in a long term although the coating wears gradually.

### EXAMPLE 4

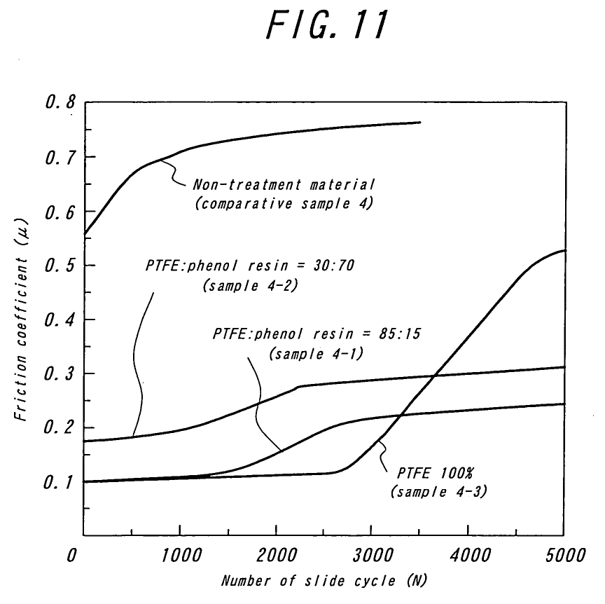

According to this embodiment 4, a slide test carried out by using a number of the sample joint seat. There was the following samples; sample 4-1 and sample 4-2 have a low friction coating by applying the treatment liquid that the composition rate of PTFE and phenol resin is 85:15 and 30:70, respectively; sample 4-3 has a low friction coating by applying the treatment liquid with PTFE 100 wt %; comparative sample 4 of untreated material that was not applied the treatment liquid differ from above samples 4-1 to 4-3. According to these samples, the slide test carried out under the condition that a surface pressure 4.9 MPa acted on each samples by a measuring pin that is made from aluminum with 3 mm diameter, and each samples slide 25 mm distance with the sliding speed 24 mm/min. As seen from FIG. 11, the friction coefficient become decrease depends on the increase of the composition rate of PTFE, but as shown by sample 4-3, if the composition rate of phenol resin which is binder becomes less than 15 wt %, the friction coefficient rises drastically at the point where the number of sliding cycle reached some value.

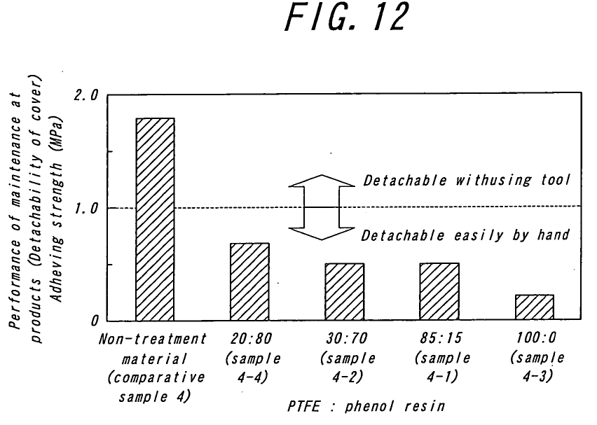

Moreover, the cover adhering strength that indicates the ease of maintenance at the products (ease of detachment of cover C) was measured about the samples and the additional sample 4-4 that is made by applying the treatment liquid that the composition rate of PTFE and phenol resin is 20:80. The measurement carried out under the condition that surface pressure is 9.8 MPa, heat treating temperature is 100° C. and heat treating period is 60 min. As shown in FIG. 12, the four samples of the embodiment 4 has non-adherence, thus the cover C is able to detach easily from the gasket by hand, but in case of the comparative sample, it was necessary to use a tool.

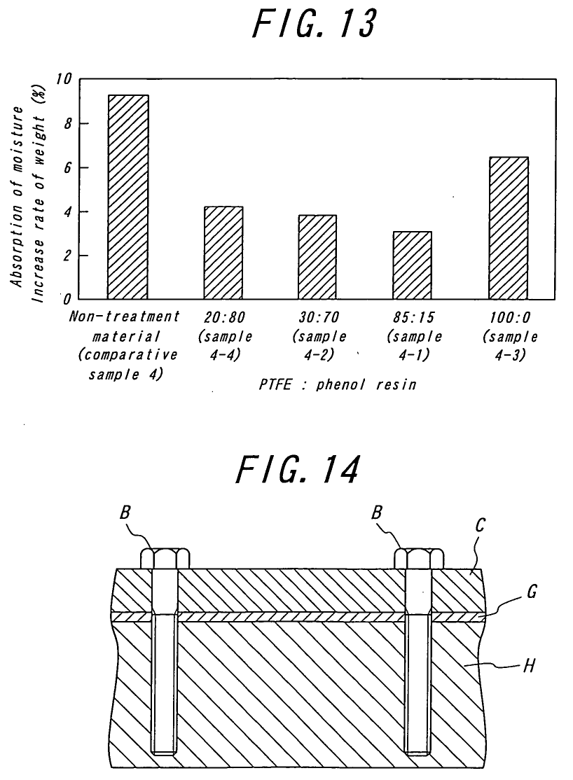

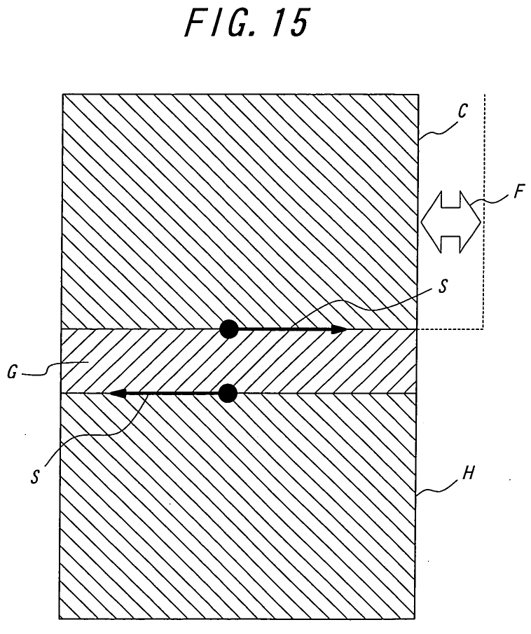

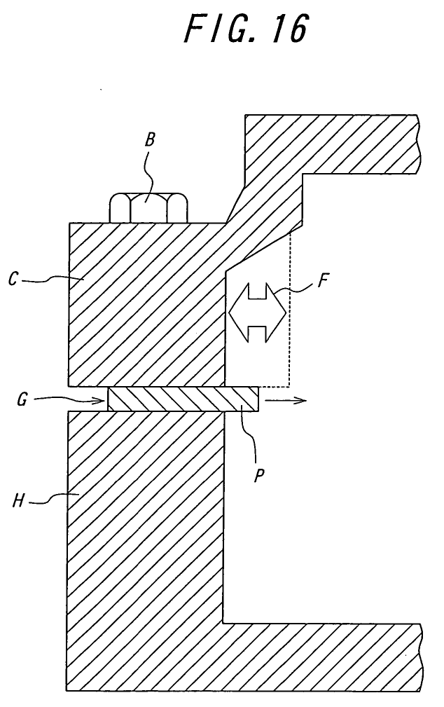

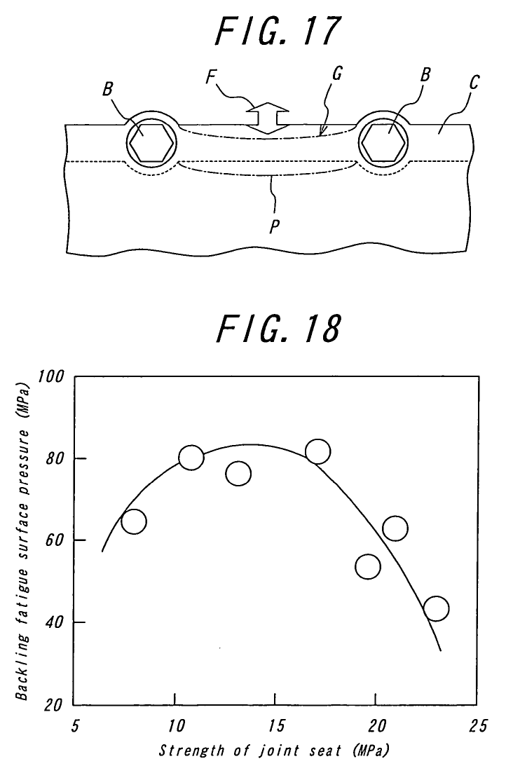

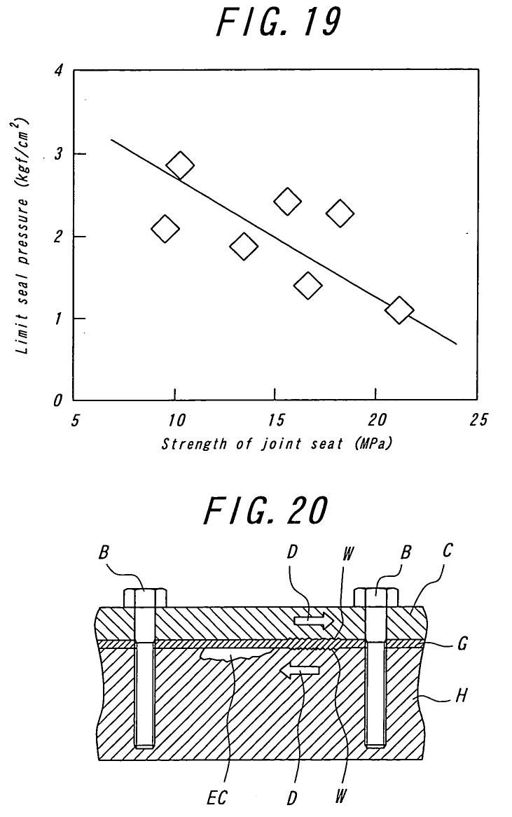

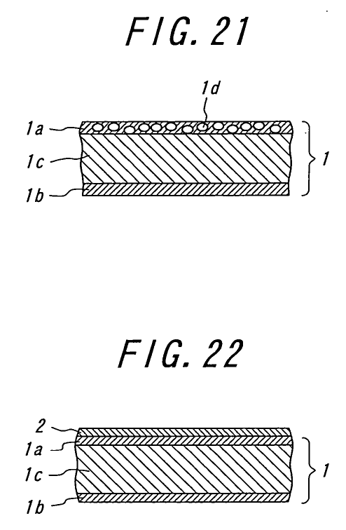

Furthermore, the weight increase rate (%) by absorbing moisture was measured about the above-mentioned samples and the comparative samples under the condition that these samples are dipped in the distilled water in 5 hours. As shown in FIG. 13, it was revealed that the samples 4-1, 4-2 and 4-4 that have the coating which includes phenol resin in the treatment liquid have the excellent water resistance because each surface of these gasket samples is covered with PTFE that is bound by phenol resin, thus, the absorption of moisture was limited.

The following Table 9 presents the evaluation of the above-mentioned result of the test and measurement by collecting these results. It is seen from this table 9 that the samples 4-1 to 4-4 of this embodiment 4 has low friction coefficient (as for sample 4-4 has no data, but it will be able to estimated from FIG. 11 based on the quantity of PTFE), excellent performance of maintenance caused from its non-adherence, and water resistance that can prevent its corrosion compared to the comparative sample. Especially, it is known that the samples 4-1 and 4-2 have high performance across a board of the result of the test. In this table 9, the unit of the values of PTFE and phenol resin is wt %, and mark “⊚” indicates “excellent”, “◯” indicates “high”, “Δ” indicates “middle” and “×” indicates “low”, respectively.

TABLE 9

| | | Phenol | low friction | performance of | |
|---|---|---|---|---|---|
| | PTFE | resin | stability | maintenance | durability |
| Sample 4-1 | 85 | 15 | ⊚ | ⊚ | ⊚ |
| Sample 4-2 | 30 | 70 | ⊚ | ⊚ | ⊚ |
| Sample 4-3 | 100 | 0 | Δ | ⊚ | Δ |
| Sample 4-4 | 20 | 80 | — | ◯ | ◯ |
| Comparative | — | — | X | X | X |
| Sample 4 | | | | | |

Moreover, this invention is not limited the above-mentioned embodiment, for example, the low friction coating 3 may be formed on both of the surface of joint seat 1, and the construction of joint seat 1 may be changed.

And the gasket material of this invention of course can be used as the gasket to the periphery of engine instead of the gasket that is inserted between the housing H and the cover C of the transmission in the above-mentioned embodiments 1-4.

### POSSIBILITY OF APPLICATION IN INDUSTRY

According to the gasket material of the first point of view of this invention, the anti-tensile force of the joint seat is increased by mutual involve of the miniaturized fiber which is composed from organic fiber and inorganic fiber and additional involve of miniaturized fiber and spicular inorganic fiber, so that, if the fretting occurs on the structural body such as housing and cover, the occurrence of the crack breakage of the gasket due to the misalignment of the gasket from its original position is prevented.

And according to the gasket material of the second point of view of this invention, one of the both outermost layers is formed as non-adhering layer with weak adherence and another one is formed as adhering layer with strong adherence, so that although the fretting occurs at the structural body such as housing and cover, the adhering layer of the gasket that is formed from the gasket material adheres the gasket to the structural body and maintain it at the original position, furthermore, the non-adhering layer gives the gasket a slip S against the structural body by a small friction force, therefore, decrease of the seal efficiency which due to the displacement of the gasket from its original position is prevented.

Moreover, according to the gasket material of the third point of view of this invention, aramid fiber that its composition is over 20 wt % and barium sulfate that its composition is 7 wt %-30 wt % enhances the strength of the joint seat with maintaining its high flexibility, so that, if the fretting occurs on the structural body such as housing and cover, the occurrence of the leakage of the sealing media due to the misalignment of the gasket from its original position and decrease of the surface pressure is prevented. And this gasket material can maintain the ingredient cost of the gasket in low cost and can make the surface of the gasket smooth and make the sealing efficiency increase sufficiently. Moreover, this joint seat can keep the low hardness of the joint seat and acquire the endurance of the gasket against the repeated compression stress, therefore, the decline of the sealing effect of the gasket due to its buckling fatigue can be prevented. Additionally, this gasket material can maintain the flexibility of the joint seat in high level and therefore, the decline of the sealing effect of the gasket due to large wear-out of the gasket can be prevented with resist the stress of thrust direction by the fretting under the influence of the surface pressure.

Furthermore, according to the gasket material of the fourth point of view of this invention, the low friction coating that is formed on the single side or the both side of said joint seat by applying the low friction treatment liquid that includes polytetrafluoroethylene can acquire sufficient low friction coefficient of the surface of the gasket, so that, if the relative displacement between the attaching surfaces of the housing H or cover C or the like and gasket G that is made from the gasket material of this invention, the fretting wear-out of the surface of the gasket G that is made from the gasket material of this invention can be prevented, and its sealing efficiency can increase drastically rather than the gasket that is made from the present joint seat.

1. A gasket material that is manufactured from a joint seat that is made from an ingredient made by mixing and kneading rubber, reinforced fiber and filler, then pressurized laminating and vulcanizing said ingredient,
characterized in that said reinforced fiber is as a sort of fibril which is composed from one or both of organic fiber and non-asbestos type inorganic fiber, and at least a part of said filler is spicular inorganic fiber and its composition is 10%-45 wt %.

2. The gasket material according to claim 1,
characterized in that a phenolic antioxidant adds to said ingredient at 2 wt %-26 wt %.

3. The gasket material according to claim 2,
characterized in that the fundamental component of the ingredient with said phenolic antioxidant is composed from the following materials;
Aramid fiber as the reinforce fiber is over 15 wt %,
NBR as the rubber material is 10%-30 wt %,
Phenolic antioxidant is 2 wt %-26 wt %,
Magnesium silica hydrate as the spicular inorganic fiber and,
The remainder is inorganic filler as the filler material.

4. The gasket material according to claim 1,
characterized in that said spicular inorganic fiber has 40 μm-200 μm of major axis of the particle.

5. A gasket material that is manufactured from a joint seat with multi-layer structure which is made from an ingredient made by mixing and kneading rubber, reinforced fiber and filler, then pressurized laminating and vulcanizing said ingredient,
characterized in that one of the both outermost layers is formed as non-adhering layer with weak adherence and another one is formed as adhering layer with strong adherence.

6. The gasket material according to claim 5,
characterized in that the adherence of said adhering layer is over 5 times of the adherence of said non-adhering layer, and the adherence of said adhering layer is over 2.5 MPa.

7. The gasket material according to claim 5,
characterized in that the component of said adhering layer is composed from the following materials;
Coumarone-indene resin is 2 wt %-15 wt %
Calcium carbonate is 5 wt %-60 wt %,
NBR is 10%-25 wt % and,
Total composition of these components is under or equal to 100 wt %.

8. A gasket material that is manufactured from a joint seat that is made from an ingredient made by mixing and kneading rubber, reinforced fiber and filler, then pressurized laminating and vulcanizing said ingredient,
characterized in that the fundamental component of the ingredient is composed from the following materials;
Aramid fiber as the reinforce fiber is over 20 wt %,
Rubber material is 23 wt %-30 wt %,
Barium sulfate as the filler is 7 wt %-30 wt % and,
The remainder is inorganic filler as the filler material.

9. The gasket material according to claim 8,
characterized in that the mean particle diameter of said barium sulfate is under 3 μm.

10. The gasket material according to claim 8,
characterized in that the specific surface area of said aramid fiber is over 6 m²/g

11. A gasket material that is manufactured from a joint seat that is made from an ingredient made by mixing and kneading rubber, reinforced fiber and filler, then pressurized laminating and vulcanizing said ingredient,
characterized in that the low friction coating is formed on the single side or the both side of said joint seat by applying the low friction treatment liquid that includes polytetrafluoroethylene.

12. The gasket material according to claim 11,
characterized in that said treatment liquid is made by mixing the emulsion of polytetrafluoroethylene with 30 wt %-85 wt % and the resol of phenol resin with 15 wt %-70 wt % with keeping the total weight percentage 100 wt %.

13. The gasket material according to claim 11,
characterized in that the thickness of said coating is over 3 μm.
